(19) United States
(12) Patent Application Publication
(10) Pub. No.: US 2024/0279985 A1
(43) Pub. Date: Aug. 22, 2024

(54) DEVICE FOR LOWERING AND RAISING BLIND

(71) Applicant: Hangzhou Jeep tower Clothing Enterprises Co., Ltd., Zhejiang (CN)

(72) Inventors: Yu PAN, Zhejiang (CN); Michael Alexander Mayer, Zhejiang (CN)

(21) Appl. No.: 18/306,409

(22) Filed: Apr. 25, 2023

(30) Foreign Application Priority Data
Feb. 17, 2023 (CN) 202320238373.7

(51) Int. Cl. E06B 9/322

(52) U.S. Cl. CPC E06B 9/322; E06B 2009/3222

(57) ABSTRACT

Disclosed is a device for lowering and raising blind, which relates to the technical field of blind, wherein the device comprises a fixing frame and a lining plate, the fixing frame is used to connect with a blind body; the lining plate articulately connects with the fixing frame; the lining plate has a first usage state and a second usage state, in the first usage state, the blind body is raised, and the lining plate contacts with the blind body to prevent the blind body from being lowered; in the second usage state, the lining plate is located at each side of the blind body, and the blind body may be performed an lowering operation or a raising operation. The application is able to be manually lowered or raised through a cooperation of the lining plate and the fixing frame without a pulling rope.

### CROSS-REFERENCES TO RELATED APPLICATIONS

This application claims the priority of Chinese patent application no. 202320238373.7, filed on Feb. 17, 2023, the entire contents of all of which are incorporated herein by reference.

### FIELD OF THE APPLICATION

The present application relates to the technical field of blind, in particular to a device for lowering and raising blind.

### BACKGROUND

Blind products are usually controlled by rolling the reel to raise or lower the blind cloth. In the market, the methods to roll the reel are rope pulling/bead pulling type, rocker type, spring-driven type, motor-driven type, etc. All these methods can raise or lower the blind, but the parts and structures thereof are relatively numerous and complex, and the operation is complicated and time-consuming. The rope pulling/bead pulling type has child safety hazards, and is easy to hang neck. The production and manufacturing costs of other types are relatively high. Therefore, there is a prospect of developing a device for lowering and raising blind that is simple and quick to operate.

### BRIEF SUMMARY OF THE DISCLOSURE

The purpose of the present application is to provide a device for lowering and raising blind, aiming to develop a device for lowering and raising blind that is simple and quick to operate.

To achieve the purpose stated above, the technical solution of the present application is to provide a device for lowering and raising blind, which comprises:
a fixing frame, the fixing frame is used to connect with a blind body;
a lining plate, the lining plate articulately connects with the fixing frame; the lining plate has a first usage state and a second usage state, in the first usage state, the blind body is raised, and the lining plate contacts with the blind body to prevent the blind body from being lowered; in the second usage state, the lining plate is located at either side of the blind body, and the blind body is able to be performed an lowering operation or a raising operation.

In one embodiment, the fixing frame comprises:
a fixing frame body, one end of the fixing frame body articulately connects with the lining plate;
two baffle plates, the baffle plates connect with the fixing frame body, and the two baffle plates are set at intervals of a certain distance;
a baffle bar, the baffle bar is set between the two baffle plates for cooperating with each of the two baffle plates to clip the blind body.

In one embodiment, the fixing frame body rotationally connects with the lining plate.

In one embodiment, the fixing frame body rotationally connects with the lining plate through a rivet structure.

In one embodiment, the lining plate is provided with a limiting section for limiting a sectional structure of the blind body.

In one embodiment, the limiting section comprises at least one of bumps and limiting slots.

In one embodiment, ends of each of the two baffle plates away from the fixing frame body are in a same orientation; an orientation of one end of the baffle bar away from the fixing frame body is the same as the orientation of the end of the baffle plates away from the fixing frame body.

In one embodiment, the baffle bar is provided in a staggered position with the baffle plate.

In one embodiment, further comprising a usage method of the device for lowering and raising blind, the usage method comprises following steps:
step 1: connecting and fixing the fixing frame with a blind through a cooperation of the two baffle plates and the baffle bar, and adjusting the lining plate to the second usage state;
step 2: turning over the blind to wrap the blind on the fixing frame;
step 3: after the blind is turned over to a predetermined length, adjusting the usage state of the lining plate to the first usage state, and fixing the usage state of the blind at this time.

The beneficial effects of the device for lowering and raising blind provided by the present application are that: compared with the prior art, the device for lowering and raising blind of the present application can be manually lowered or raised through a cooperation of the lining plate and the fixing frame without a pulling rope, which is safe, good in applicability, simple, and low in production and manufacturing cost. The device for lowering and raising blind also has characteristics of a simple and quick operation.

### BRIEF DESCRIPTION OF THE DRAWINGS

In order to illustrate the technical solutions in the embodiments of the present application, a plurality of drawings, which are required to be used in the embodiments or the prior art, are briefly described below. Obviously, the drawings in the following description are merely some embodiments of the present application. For those skilled in the art, a plurality of other drawings can be obtained according to the present drawings without any inventive efforts.

FIG. 1 is a schematic structure diagram of a device for lowering and raising blind provided by the embodiment of the present application wherein the device is applied to a blind body; it should be noted that, a short blind cloth is in front of the blind body (a long blind cloth), and the blind body connects with the short blind cloth through a beam.

FIG. 2 is a schematic structure diagram of the device for lowering and raising blind provided by the embodiment of the present application.

FIG. 3 is an exploded diagram of the device for lowering and raising blind provided by the embodiment of the present application.

FIG. 4 is a schematic structure diagram of a fixing frame adopted by the device for lowering and raising blind provided by the embodiment of the present application.

FIG. 5 is a schematic structure diagram of a lining plate adopted by the device for lowering and raising blind provided by the embodiment of the present application.

FIG. 6 is a schematic diagram of a rear side of the blind body, when the device for lowering and raising blind provided by the embodiment of the present application is mounted on the blind body; it should be noted that, a baffle plate located at a bottom of the FIG. 6 is glued on the rear side of the long blind cloth folded over through glue or glue gun, thus the bottom baffle plate is hidden by the long blind cloth and is invisible.

FIG. 7 is a schematic structure diagram of a second device for lowering and raising blind provided by the embodiment of the present application.

FIG. 8 is a schematic diagram of a front side of the blind body, when the second device for lowering and raising blind provided by the embodiment of the present application is mounted on the blind body.

FIG. 9 is a schematic diagram of a rear side of the blind body, when the second device for lowering and raising blind provided by the embodiment of the present application is mounted on the blind body.

FIG. 10 is a schematic structure diagram of a third device for lowering and raising blind provided by the embodiment of the present application.

FIG. 11 is a schematic diagram of a front side of the blind body, when the third device for lowering and raising blind provided by the embodiments of the present application is mounted on the blind body.

FIG. 12 is a schematic diagram of a rear side of the blind body, when the third device for lowering and raising blind provided by the embodiment of the present application is mounted on the blind body.

FIG. 13 is a schematic structure diagram of a fourth device for lowering and raising blind provided by the embodiment of the present application.

FIG. 14 is a schematic diagram of a front side of the blind body, when the fourth device for lowering and raising blind provided by the embodiment of the present application is mounted on the blind body.

FIG. 15 is a schematic diagram of a rear side of the blind body, when the fourth device for lowering and raising blind provided by the embodiment of the present application is mounted on the blind body.

Wherein 1. rivet structure; 2. blind body; 3. fixing frame; 31. fixing frame body; 32. baffle plate; 33. baffle bar; 4. lining plate; 41. limiting section.

### DETAILED DESCRIPTION OF EMBODIMENTS

In order to make the technical problems to be solved, the technical solutions, and the advantages of the present application clearer and more explicit, further detailed descriptions of the present application are stated herein, referencing to the attached drawings and the embodiments of the present application. It should be understood that the detailed embodiments of the application described herein are merely used to explain the present application, instead of limiting the present application.

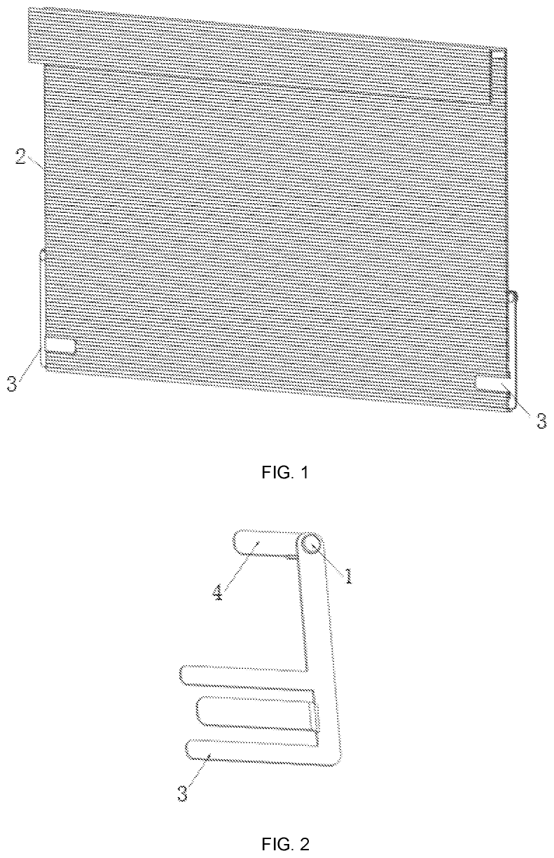

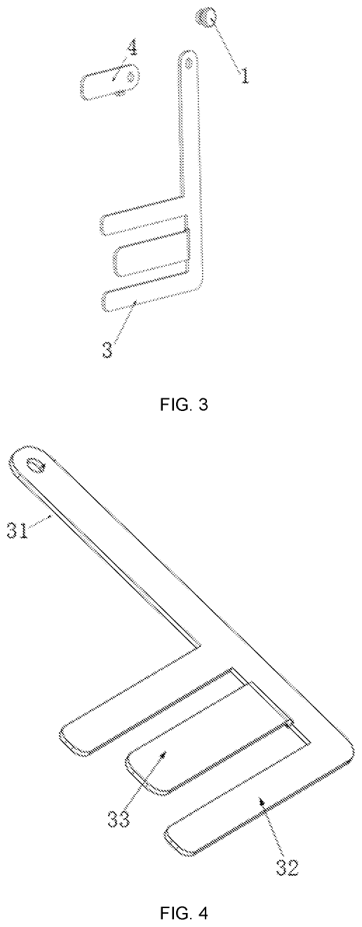

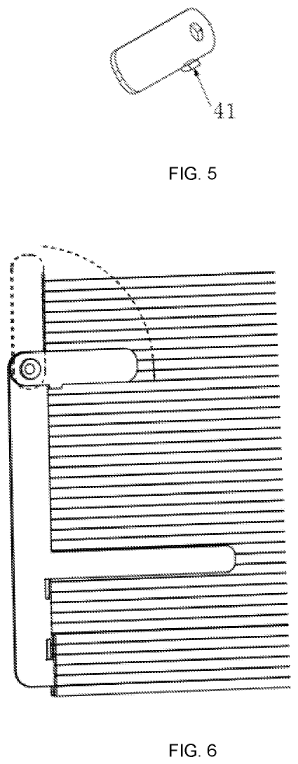

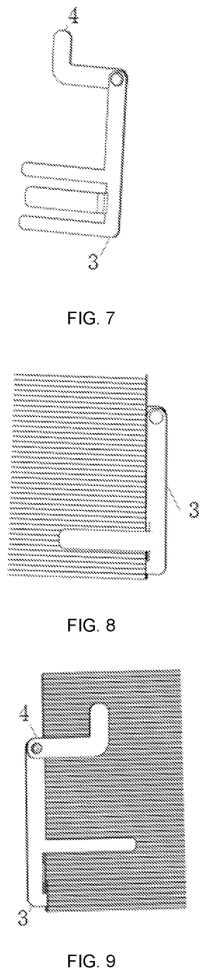

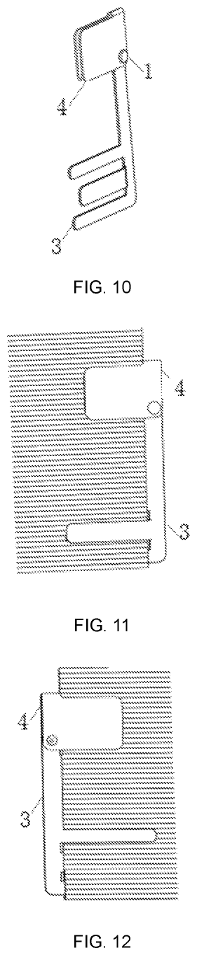

Referring together to FIGS. 1 to 12, now describing a device for lowering and raising blind provided by the present application. The device for lowering and raising blind comprises a fixing frame 3 and a lining plate 4, the fixing frame 3 is used to connect with a blind body 2; the lining plate 4 and the fixing frame 3 are articulately connected; the lining plate 4 has a first usage state and a second usage state. In the first usage state, the blind body 2 is raised, the lining plate 4 contacts with the blind body 2 to prevent the blind body 2 from being lowered; in the second usage state, the lining plate 4 is located at either side of the blind body 2, and the blind body 2 may be performed an lowering operation or a raising operation.

In use, the fixing frame 3 is fixedly connected to the blind body 2, and then adjusting the lining plate 4 to achieve a limitation or a release of the blind body 2. The fixing frame 3 is mounted on edges of two sides of a bottom of the blind body 2. The first usage state is a raised state, that is the lining plate 4 is closed, and the lining plate 4 is at 90° with the fixing frame 3, and the lining plate 4 is located at a rear of the blind body 2 to prevent the blind body 2 from being lowered or being raised. The second usage state is an open state, that is the lining plate 4 is open, and the lining plate 4 is located on two sides of the blind body 2, and the blind body 2 may be performed being lowered or being raised.

The device for lowering and raising blind provided by the present application, compared with the prior art, may be manually lowered or raised through a cooperation of the lining plate 4 and the fixing frame 3 without a pulling rope, which is safe, good in applicability, simple, and low in production and manufacturing cost. The device for lowering and raising blind also has characteristics of a simple and quick operation.

As one embodiment of the present application, referring together to FIGS. 1 to 12, the fixing frame 3 comprises: a fixing frame body 31, a baffle plate 32, and a baffle bar 33, one end of the fixing frame body 31 is articulately connected with the lining plate 4; two baffle plates 32 are provided, the baffle plates 32 are connected with the fixing frame body 31, and the two baffle plates 32 are set at intervals of a certain distance; the baffle bar 33 is set between the two baffle plates 32 for cooperating with each of the baffle plate 32 to clip the blind body 2. Through a cooperation of the baffle bar 33 and the baffle plate 32, a fixed connection between the fixing frame and the blind body 2 is achieved, which has characteristics of a simple structure, a low production cost, sturdy, and durable.

In the present embodiment, ends of each of the two baffle plates 32 are in the same orientation that away from the fixing frame body 31; an orientation of one end of the baffle bar 33 away from the fixing frame body 31 is the same as the orientation of the ends of the baffle plates 32 away from the fixing frame body 31. One end of each baffle plate 32 is connected to one end of the fixing frame body 31 away from the lining plate 4. In an embodiment, the one end of each baffle plate 32 is connected to a side of the one end of the fixing frame body 31 away from the lining plate 4. One baffle plate 32 is set above another baffle plate 32.

In the present embodiment, the baffle bar 33 is provided in a staggered position with the baffle plate 32. The baffle bar 33 is connected to the fixing frame body 31 through a staggered connection section. So that a plane in which the baffle bar 33 is located and a plane in which the two baffle plates 32 are located are not the same. In an embodiment, a side of the fixing frame body 31 may be divided into two layers, an upper layer is provided with the baffle bar 33. The baffle bar 33 is rectangular. A lower layer of the fixing frame body 31 is provided with the baffle plates 32. The baffle plates 32 are polygonal. The blind body 2 is fixedly set between the upper layer and the lower layer, i.e., between the baffle bar 33 and the baffle plate 32. The fixing frame 3 is mounted on the edges of the two sides of the bottom of the blind body 2.

As an embodiment of the present application, referring together to FIGS. 1 to 12. The fixing frame body 31 is rotationally connected with the lining plate 4. A setting method of a rotational connection facilitates adjusting a usage state of the lining plate 4.

In the present embodiment, the fixing frame body 31 is connected with the lining plate 4 through a rivet structure 1. The fixing frame body 31 is provided with a first rivet mounting hole. The lining plate 4 is provided with a second rivet mounting hole which matches the first rivet mounting hole. The lining plate 4 is fixedly connected with the fixing frame 3 through the rivet structure 1.

In the present embodiment, the lining plate 4 is provided with a limiting section 41 for limiting a sectional structure of the blind body 2. A setting of the limiting section 41 improves an ability of the lining plate 4 in the first usage state to limit and fix the blind body 2.

In the present embodiment, the limiting section 41 comprises at least one of bumps and limiting slots.

The lining plate 4 is a movable section fixed on the fixing frame 3 through the rivet structure 1. The lining plate 4 may rotate relative to the fixing frame 3 around the rivet structure 1. The lining plate 4 may be designed into different shapes according to needs of different blind bodies 2. In some embodiments, the limiting section 41 is a boss, which is used to prevent the lining plate 4 from continually rotating after the lining plate 4 rotates a certain angle relative to the fixing frame 3, thus the limiting section 41 plays a role of limiting. When the lining plate 4 is opened, the lining plate 4 is located on either side (a left side or a right side) of the blind body 2, so that the blind body 2 may be lowered and raised. When the lining plate 4 is closed, the lining plate 4 is 90 degrees from the fixing frame 3 and is located at the rear of the blind body 2 to prevent the blind from being lowered or being raised.

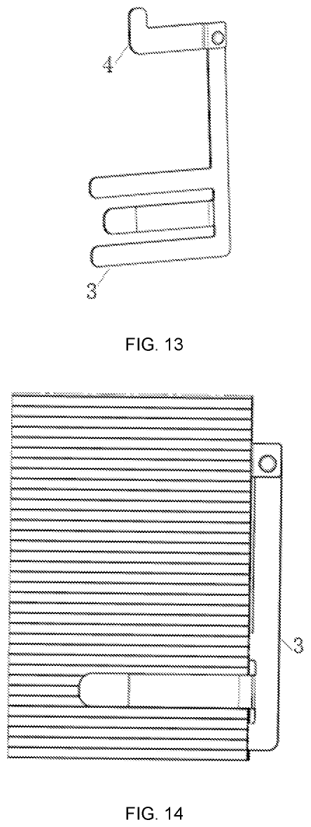

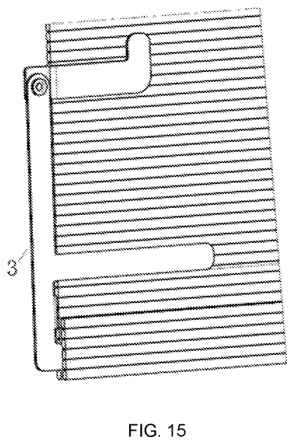

As an embodiment of the present application, referring together to FIGS. 12 to 15. The lining plate 4 is provided with the limiting section 41 for limiting the sectional structure of the blind body 2. The limiting section 41 is a bending plate structure.

It should be noted that there is no limit on a number of the device for lowering and raising blind. Users may choose one, two or a plurality of the devices to use according to a specific situation.

The present application further comprises a usage method of the device for lowering and raising blind, the usage method comprises the following steps:
step 1: connecting and fixing the fixing frame 3 with the blind through a cooperation of the two baffle plates 32 and the baffle bar 33, and adjusting the lining plate 4 to the second usage state;
step 2: turning over the blind to wrap the blind on the fixing frame 3;
step 3: after the blind is turned over to a predetermined length, adjusting the usage state of the lining plate 4 to the first usage state, and fixing the usage state of the blind at this time.

The present application further provides another usage method of the device for lowering and raising blind. The lining plate 4 of the device for lowering and raising blind is fixedly connected with the fixing frame 3, the another usage method comprises the following steps:
step 1: connecting and fixing the fixing frame 3 with the blind through a cooperation of the two baffle plates 32 and the baffle bar 33;
step 2: turning over the blind to wrap the blind on the fixing frame 3;
step 3: after the blind is turned over to a predetermined length, pushing the fixing frame 3 to make the lining plate 4 fix the usage state of the blind at this time.

The above descriptions are only some embodiments of the present application, which are not intended to limit the present application. Any modifications, equivalent replacements, and improvements, etc., which are made within the spirit and principle of the present application, should all belong to the protecting scope of the present application.

What is claimed is:

1. A device for lowering and raising blind, wherein comprising:
a fixing frame (3), the fixing frame (3) is used to connect with a blind body (2);
a lining plate (4), the lining plate (4) articulately connects with the fixing frame (3); the lining plate (4) has a first usage state and a second usage state, in the first usage state, the blind body (2) is raised, and the lining plate (4) contacts with the blind body (2) to prevent the blind body (2) from being lowered; in the second usage state, the lining plate (4) is located at either side of the blind body (2), and the blind body (2) is able to be performed an lowering operation or a raising operation.

2. The device for lowering and raising blind according to claim 1, wherein the fixing frame (3) comprises:
a fixing frame body (31), one end of the fixing frame body (31) articulately connects with the lining plate (4);
a baffle plate (32), two baffle plates (32) are provided, the baffle plates (32) connect with the fixing frame body (31), and the two baffle plates (32) are set at intervals of a certain distance;
a baffle bar (33), the baffle bar (33) is set between the two baffle plates (32) for cooperating with each of the two of the baffle plates (32) to clip the blind body (2).

3. The device for lowering and raising blind according to claim 2, wherein the fixing frame body (31) rotationally connects with the lining plate (4).

4. The device for lowering and raising blind according to claim 3, wherein the fixing frame body (31) rotationally connects with the lining plate (4) through a rivet structure (1).

5. The device for lowering and raising blind according to claim 3, wherein the lining plate (4) is provided with a limiting section (41) for limiting a sectional structure of the blind body (2).

6. The device for lowering and raising blind according to claim 5, wherein the limiting section (41) comprises at least one of bumps and limiting slots.

7. The device for lowering and raising blind according to claim 2, wherein ends of each of the two baffle plates (32) have a same orientation away from the fixing frame body (31); an orientation of one end of the baffle bar (33) away from the fixing frame body (31) is the same as the orientation of the ends of the baffle plates (32) away from the fixing frame body (31).

8. The device for lowering and raising blind according to claim 7, wherein the baffle bar (33) is provided in a staggered position with the baffle plate (32).

9. A usage method of the device for lowering and raising blind according to claim 8, wherein comprising:
step 1: connecting and fixing the fixing frame (3) with a blind through a cooperation of the two of the baffle plates (32) and the baffle bar (33), and adjusting the lining plate (4) to the second usage state;
step 2: turning over the blind to wrap the blind on the fixing frame (3);
step 3: after the blind is turned over to a predetermined length, adjusting the usage state of the lining plate (4) to the first usage state, and fixing the usage state of the blind at this time.
